(19) United States
(12) Patent Application Publication
(10) Pub. No.: US 2023/0189372 A1
(43) Pub. Date: Jun. 15, 2023

(54) CONTROL METHOD, COMMUNICATION APPARATUS, AND INFORMATION PROCESSING APPARATUS

(71) Applicant: Canon Kabushiki Kaisha, Tokyo (JP)

(72) Inventor: NAOKI SHINOZUKA, Kanagawa (JP)

(21) Appl. No.: 18/062,658

(22) Filed: Dec. 7, 2022

(30) Foreign Application Priority Data
Dec. 14, 2021 (JP) 2021-202769

(51) Int. Cl. H04W 76/18; H04W 76/15

(52) U.S. Cl. CPC H04W 76/18; H04W 76/15

(57) ABSTRACT

An information processing apparatus transmits, before trying to establish a second connection via an external access point identified by identification information provided to a communication apparatus, to the communication apparatus, an instruction for controlling the communication apparatus such that the communication apparatus starts a setting mode upon failure in establishment of the second connection.

### BACKGROUND OF THE INVENTION

### Field of the Invention

The present invention relates to a control method, a communication apparatus, and an information processing apparatus.

### Description of the Related Art

As a connection method between devices, wireless infrastructure connection for connecting the devices via an external access point is known. However, due to various factors, establishment of wireless infrastructure connection may fail. Japanese Patent Laid-Open No. 2021-022877 discloses that if it is determined that communication between a communication apparatus and an information processing apparatus via an external apparatus is impossible, a user is notified of at least one of the communication error causing the communication failure and the method for removing the communication error.

### SUMMARY OF THE INVENTION

The present invention provides a storage medium storing a program for reducing the burden on a user upon failure in establishment of connection between an information processing apparatus and a communication apparatus via an external access point, a communication apparatus, and an information processing apparatus.

The present invention in one aspect provides a control method of an information processing apparatus that communicates with a communication apparatus, comprising: establishing, between the information processing apparatus and a communication apparatus that has started a wireless connection setting mode, temporary first connection without intervention of an external access point of the communication apparatus and the information processing apparatus; providing, using the first connection, the communication apparatus with identification information for identifying the external access point; trying to establish, between the communication apparatus and the information processing apparatus, second connection via the external access point identified by the identification information provided to the communication apparatus; and transmitting, before trying to establish the second connection, to the communication apparatus, an instruction for controlling the communication apparatus such that the communication apparatus starts the setting mode upon failure in establishment of the second connection.

Further features of the present invention will become apparent from the following description of exemplary embodiments (with reference to the attached drawings).

### BRIEF DESCRIPTION OF THE DRAWINGS

FIG. 1A is a view for explaining a system configuration according to an embodiment;

FIG. 1B is a view for explaining the system configuration according to the embodiment;

FIG. 1C is a view for explaining the system configuration according to the embodiment;

FIG. 2 is a block diagram showing the configuration of a communication system including the hardware arrangement of a PC and the hardware arrangement of a printer according to the embodiment;

FIGS. 3A to 3C are flowcharts illustrating a process example of the CPU of the PC and the CPU of the printer;

FIG. 4 is a flowchart illustrating a process example of the CPU of the PC;

FIG. 5 is a flowchart illustrating a process example of the CPU of the printer;

FIG. 6A is a view showing an example of a screen to be displayed;

FIG. 6B is a view showing an example of another screen to be displayed;

FIG. 7A is a view showing an example of still another screen to be displayed;

FIG. 7B is a view showing an example of still another screen to be displayed; and

FIG. 8 is a view showing an example of an automatic connection process failure list.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

If establishment of wireless infrastructure connection fails, a user may be required to manually operate a communication apparatus or refer to a manual or the like. From the viewpoint of improvement of user convenience, it is desirable to reduce the burden on a user upon failure in establishment of wireless infrastructure connection.

According to the present disclosure, it is possible to reduce the burden on a user upon failure in establishment of connection between an information processing apparatus and a communication apparatus via an external access point.

A process performed between a personal computer (to be referred to as a PC hereinafter) as an example of an information processing apparatus and a printer as an example of a communication apparatus will be described below. When establishing wireless infrastructure connection between the PC and the printer, for example, the following method is conceivable. First, the PC establishes temporary connection to the printer in a wireless setting mode (a setting mode for establishing wireless infrastructure connection) without intervention of an external access point (to be referred to as an “AP” hereinafter). Then, the PC transmits, to the printer via the temporary connection, information regarding the AP to which the printer connects when wireless infrastructure connection is established. The printer connects to the target AP based on the received information.

More specifically, the PC acquires, from the printer, a list of APs to which the printer can connect, and automatically determines whether the AP that was connected to the PC is included in the list. If the AP is included, the PC transmits information regarding the AP to the printer. The printer connects to the target AP using the received information. Examples of information regarding the AP are the identification information (Service Set Identifier (SSID) or the like) of the AP and the authentication information (password or the like) to be used in the authentication process of the AP.

Here, if the printer fails to connect to the AP, the PC may prompt the user to directly operate the printer to make the printer transition to the wireless setting mode again or connect to the AP.

However, the operation as described above may be a burden on the user. In addition, the user may not be able to make the printer transition to the wireless setting mode again or connect to the AP by direct operation of the printer. For example, when the user purchases the printer and powers it on for the first time, if the printer is a model that is activated in a special mode at arrival for making initial settings, it may be difficult for the user to make settings by directly operating the printer main body. Further, assume a case in which wireless infrastructure connection between the PC and the printer is established before the user completes the necessary initial settings upon purchase of the printer, the PC acquires the status from the connected printer at any time, and the user is guided in the setting method on the PC in synchronism with the status of the printer. In this case, since the initial settings of the printer are incomplete, if the printer fails to connect to the AP, the user is required to complete all of the necessary initial settings of the printer while referring to a manual or the like. However, guidance by the manual not only puts a burden on the user but also causes some users to skip a necessary procedure or perform an incorrect operation. Therefore, it is desirable that even if the printer fails to connect to the AP, the printer can retry wireless setting without requiring the user to operate the printer. To solve the above problems, in this embodiment, upon establishment of temporary connection to the printer, the PC transmits, to the printer, an instruction to transition to the wireless setting mode again depending on the condition. If establishment of wireless infrastructure connection to the PC fails, the printer transitions to the wireless setting mode again. With this, the connection operation between the PC and the printer can be continued without requiring the user to operate the printer, and improvement of convenience can be expected. The specific configurations according to this embodiment will be described below in detail.

### System Configuration

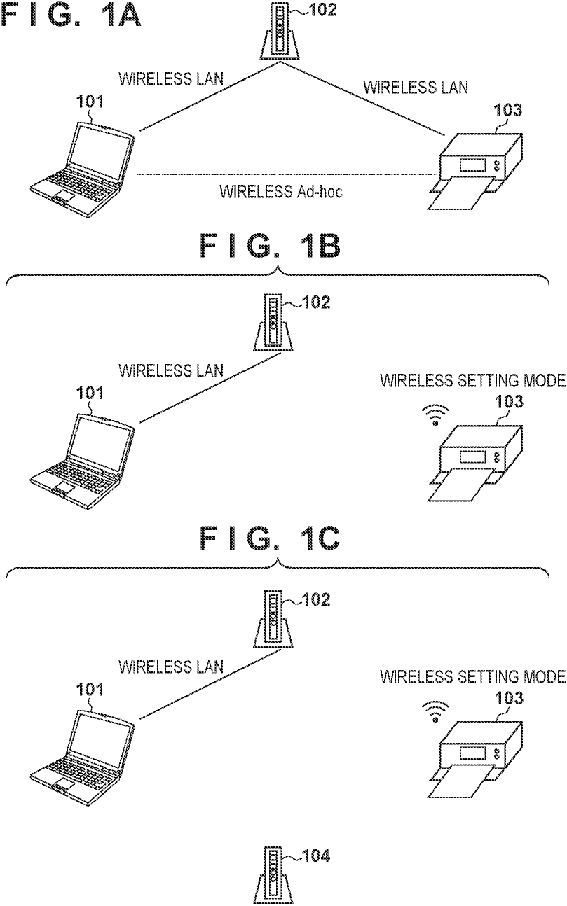

FIGS. 1A to 1C are views each for explaining a system configuration according to an embodiment. FIG. 1A shows a state in which a PC 101 and an AP 102 are connected to each other by a wireless LAN. A printer 103 is also connected to the AP 102. That is, the PC 101 can communicate with the printer 103 via the AP 102, and wireless infrastructure connection has been established. In wireless infrastructure connection, a network environment can be constructed in which the PC 101 can intercommunicate with a plurality of devices.

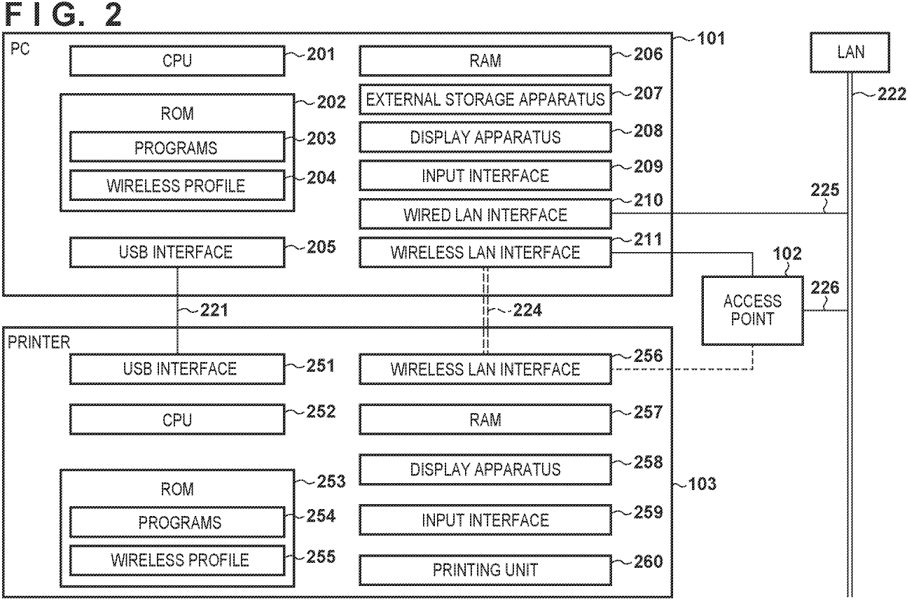

On the other hand, the PC 101 and the printer 103 can also perform peer to peer connection (to be referred to as P2P connection hereinafter) by wireless direct connection. However, during wireless direct connection, the PC 101 and the printer 103 use wireless LAN interfaces 211 and 256 (see FIG. 2) in wireless direct connection, and thus cannot communicate with other devices. Therefore, wireless direct connection is often used as temporary connection. Note that in this embodiment, as an example of connection (direct connection) between the PC 101 and the printer 103 without intervention of an external AP, connection in which the printer 103 operates as an access point (parent device) and the PC 101 operates as a station (child device) is exemplified, but another known method/form may be used to establish direct connection between the PC 101 and the printer 103. For example, direct connection between the PC 101 and the printer 103 may be established by an Ad-hoc method. Note that in this embodiment, the wireless setting mode is a mode in which the printer 103 operates as an access point for establishing wireless direct connection and performing communication via the established connection, and the SSID of this access point is a unique SSID to be described later. In addition, in the wireless setting mode, the printer 103 cannot execute some functions such as printing and scanning. The printer 103 may be capable of operation in another direct connection mode for direct connection, which is a mode different from the wireless setting mode. The printer 103 also operates as an access point in the other direct connection mode, but the SSID and password of this access point may be arbitrarily set by the user. In the other direct connection mode, functions such as printing and scanning may also be executable. A print job or the like may be received by the printer 103 via the connection between the PC 101 and the printer 103 operating in the other mode.

Although details will be described later, the PC 101 performs a process of connecting the printer 103, that starts the wireless setting mode and operates in the wireless setting mode, to the AP 102 by wireless LAN connection. To do this, the PC 101 transmits, to the printer 103 operating in the wireless setting mode, wireless network connection setting information using temporary wireless direct connection, thereby connecting the printer 103 to the AP 102. Note that FIGS. 1B and 1C will be described later. The PC 101 may execute, by the communication with the printer 103 operating in the wireless setting mode, a process other than the process of connecting the printer 103 to the AP 102. For example, the PC 101 may use the temporary wireless direct connection to acquire, from the printer 103 operating in the wireless setting mode, the connection information (SSID and password) required to connect to the printer 103 operating in another direct connection mode. Further, the PC 101 may transmit, to the printer 103 operating in the wireless setting mode, an instruction to start an operation in the other direct connection mode. Thus, direct connection between the PC 101 and the printer 103 operating in the other direct connection mode may be established.

FIG. 2 is a view showing the configuration of a communication system including the hardware arrangement of the PC 101 and the hardware arrangement of the printer 103 according to the embodiment.

### Arrangement of PC 101

The PC 101 includes a CPU 201, a ROM 202, a RAM 206, an external storage apparatus 207, a display apparatus 208, an input interface 209, a USB interface 205, a wired LAN interface 210, and the wireless LAN interface 211. Note that the PC 101 may not include some components such as the USB interface 205 and the wired LAN interface 210.

The CPU 201 implements various processes by reading out programs 203 stored in the ROM 202 into the RAM 206 and executing them. The RAM 206 functions as a working memory of the CPU 201.

The ROM 202 stores programs to be executed by the CPU 201 and various information. For example, the ROM 202 stores the programs 203 corresponding to various processes including the program (to be described later in detail) of a wireless network setting process for instructing the printer 103 to set the wireless network, a wireless profile 204, and the like.

The wireless profile 204 is information including the specification information (SSID or the like) of the AP 102 connected by the wireless LAN interface 211, the authentication information (password or the like) to be used in an authentication process, and the like. The wireless profile 204 is stored and managed when the CPU 201 executes the OS stored in the external storage apparatus 207. That is, the external storage apparatus 207 functions as a storage unit that stores various information such as the wireless profile 204 in the PC 101.

When the program (application or the like) of the wireless network setting process is installed on the PC 101, the unique SSID that is uniquely set for the printer 103 is also stored in the ROM 202. Here, the SSID unique to the printer 103 is the SSID that is sent by the printer 103 on beacon information for temporary connection. Further, the unique SSID is an SSID that cannot be arbitrarily changed by the user.

The external storage apparatus 207 saves the operating system (to be referred to as the “OS” hereinafter), a printer driver, and other various data.

The PC 101 can perform P2P communication with the printer 103 via a USB cable 221 by the USB interface 205 or via wireless direct connection 224 by the wireless LAN interface 211. The PC 101 can also connect to a LAN 222 via an Ethernet cable 225. If the printer 103 can also connect to the LAN 222, the PC 101 and the printer 103 can communicate with each other on the same LAN 222 environment. Further, when the PC 101 connects to the AP 102 by wireless infrastructure connection and the AP 102 connects to the LAN 222 via an Ethernet cable 226, the PC 101 can connect to the LAN 222.

### Arrangement of Printer 103

The printer 103 includes a USB interface 251, a CPU 252, a ROM 253, the wireless LAN interface 256, a RAM 257, a display apparatus 258, an input interface 259, and a printing unit 260.

The CPU 252 implements various processes by reading out programs stored in the ROM 253 into the RAM 257 and executing them. The RAM 257 functions as a working memory of the CPU 252.

The ROM 253 stores programs 254 to be executed by the CPU 252, and various information. The information stored in the ROM 253 includes a wireless profile 255. Here, the wireless profile 255 is information including settings such as the specification information (SSID or the like) or authentication information (password or the like) of the AP 102 connected by the wireless LAN interface 256. The wireless profile 255 is stored and managed when the CPU 252 executes the program 254 stored in the ROM 253.

The ROM 253 also stores the above-described SSID unique to the printer 103. The unique SSID is uniquely decided for the manufacturer or printer model of the printer 103. The wireless LAN interface 256 of the printer 103 can operate as an AP identified by the unique SSID. Accordingly, as in the case in which the PC 101 connects to the printer 103 via the AP 102, the PC 101 can connect directly to the printer 103 operating as an AP.

The printer 103 can perform P2P communication with the PC 101 via the USB cable 221 by the USB interface 251 or via the wireless direct connection 224 by the wireless LAN interface 256. When the printer 103 connects to the AP 102 by wireless infrastructure connection and the AP 102 connects to the LAN 222 via the Ethernet cable 226, the printer 103 can connect to the LAN 222. Note that the printer 103 may not include some components such as the USB interface 251.

In the description of FIG. 2, for example, the PC 101 and the printer 103 share the processes as described above, but they may share the processes in another manner.

### Process Example

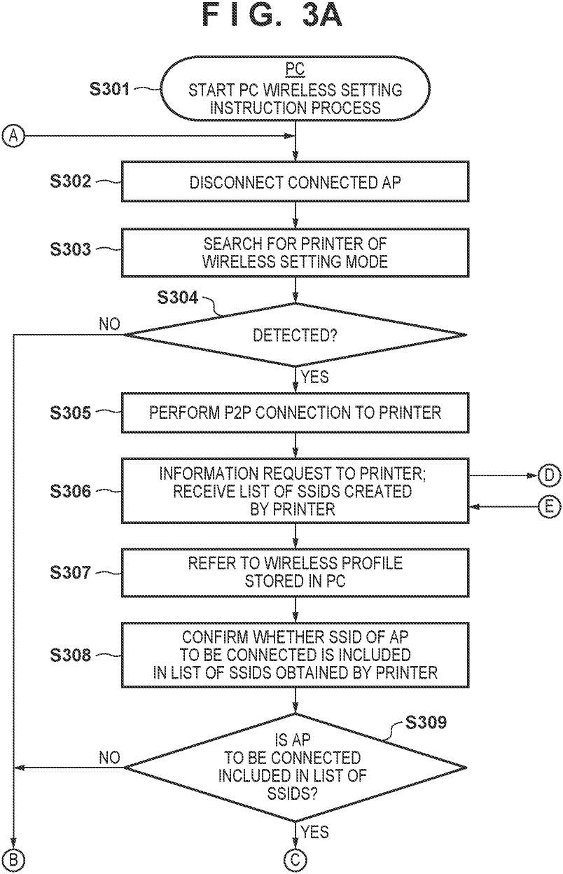

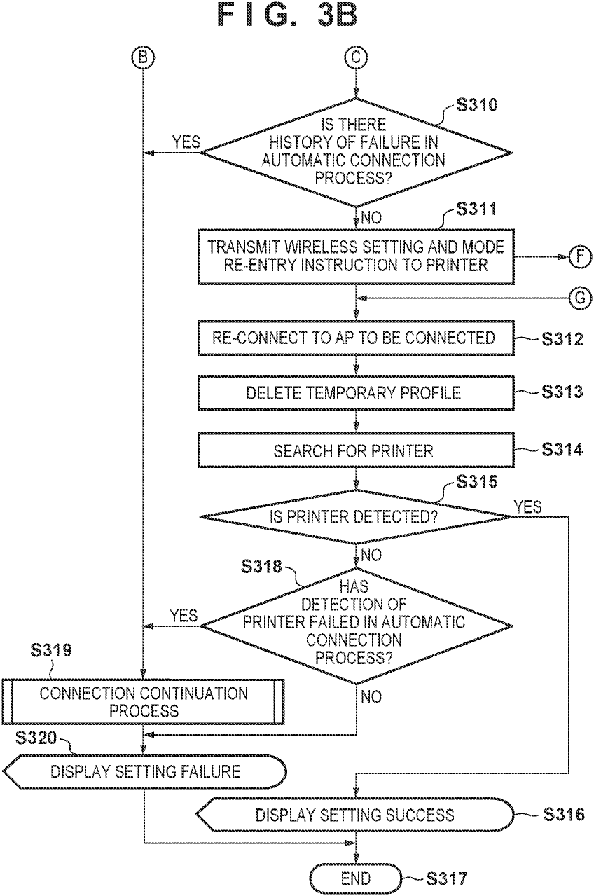

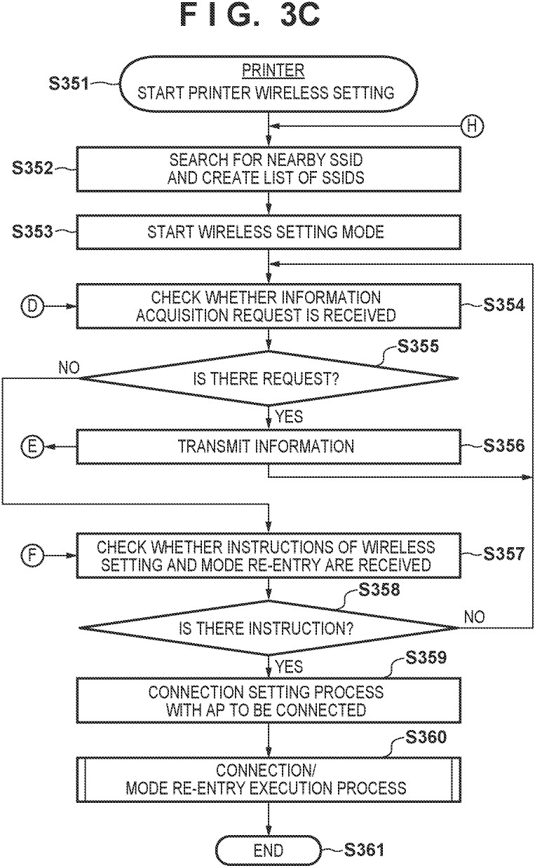

With reference to FIGS. 3 to 5, a process example of the CPU 201 and the CPU 252 will be described. More specifically, a process for performing wireless setting (setting for establishing wireless infrastructure connection) of the printer 103, and a process for continuing wireless setting upon failure in the wireless setting will be described. More specifically, continuation of a process for establishing wireless infrastructure connection in accordance with the cause of failure in the wireless setting will be described.

Note that in the following description, a connection method in which the PC 101 and the printer 103 establishes temporary direct connection (step S305) and the PC 101 instructs the printer 103 to perform wireless setting (step S311) is referred to as an automatic connection process.

FIGS. 3A to 3C are flowcharts illustrating an example of the process according to the embodiment, which is performed when the printer performs wireless setting instructed by the PC 101. The process by the PC 101 is implemented when the CPU 201 reads out the program 203 stored in the ROM 202 into the RAM 206 and executes it. The process by the printer 103 is implemented when the CPU 252 reads out the program 254 stored in the ROM 253 into the RAM 257 and executes it. Note that in this example, the PC 101 has already connected to the external AP 102, and the SSID and password of the AP 102 are stored in the wireless profile 204. FIG. 1B shows the system configuration at this time.

### Process Example of PC 101

First, the process of the CPU 201 of the PC 101 will be described.

In step S301, the CPU 201 causes the display apparatus 208 to display a predetermined screen by the program (application or the like) of the network setting process included in the programs 203. If the user makes, on the screen, a predetermined instruction to connect the PC 101 to the printer, the CPU 201 starts a following process for a wireless setting instruction (wireless setting instruction process).

In step S302, the CPU 201 disconnects wireless connection to the AP 102. This is performed to establish wireless direct connection to the printer 103 by the PC 101.

In step S303, the CPU 201 searches for the printer 103 set in the wireless setting mode. This is performed to detect the printer 103 with which temporary wireless direct connection can be established. In step S304, if the printer 103 has been detected by the processing in step S303, the CPU 201 advances to step S305; otherwise, the CPU 201 advances to step S319. More specifically, the CPU 201 performs processing of detecting the AP corresponding to the SSID unique to the printer 103, and determines whether the detection is successful.

In step S305, the CPU 201 causes the wireless LAN interface 211 to perform wireless direct connection (P2P connection) to the printer 103. More specifically, the CPU 201 connects the wireless LAN interface 211 to the AP of the SSID unique to the printer 103. That is, the CPU 201 connects the wireless LAN interface 211 to the wireless LAN interface 256 that functions as the AP in the printer 103.

In step S306, the CPU 201 sends an information acquisition request to the printer 103, and receives a list of SSIDs by obtaining a response from the printer 103. The list of SSIDs is a list of SSIDs of nearby APs searched for by the printer 103 to acquire beacon information. Details will be described later. Further, in step S306, the CPU 201 also receives the identification information (for example, MAC address or the like) of the printer 103 from the printer 103.

In step S307, the CPU 201 refers to the wireless profile 204 stored in the PC 101 (ROM 202). Here, the CPU 201 acquires the wireless profile including the SSID of the AP 102 to which the PC 101 has been connected at the start of the process illustrated in FIGS. 3A to 3C and the wireless connection has been disconnected in step S302.

In step S308, the CPU 201 confirms whether the SSID of the AP 102 acquired in step S307 is included in the list of SSIDs obtained in step S306. In step S309, as a result of confirmation in step S308, if the SSID of the AP 102 acquired in step S307 is included in the list of SSIDs, the CPU 201 advances to step S310; otherwise, the CPU 201 advances to step S319. It can be said that, in steps S308 and S309, it is determined whether the printer 103 detects the AP 102 that has been disconnected from the PC 101 in step S302 so that the printer 103 can connect to the AP 102. Note that in this embodiment, the AP 102 that has been disconnected from the PC 101 in step S302 is sometimes referred to as the connection target AP 102 of the printer 103.

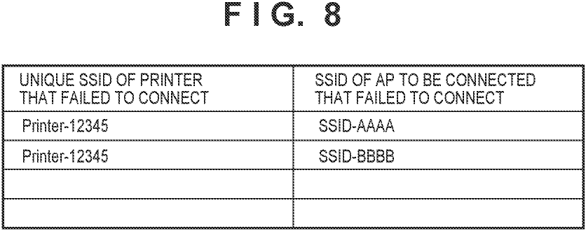

In step S310, the CPU 201 confirms whether there is a history of failure in an automatic connection process. If there is a history of failure, the CPU 201 advances to step S319; otherwise, the CPU 201 advances to step S311. The CPU 201 refers to an automatic connection process failure list (see FIG. 8) to determine whether there is a history of failure in wireless setting between the printer 103 and the connection target AP 102.

In step S311, the CPU 201 transmits, to the printer 103, a wireless setting instruction, an instruction to transition to the wireless setting mode again upon failure in the wireless setting, and the identification information (MAC address or the like) of the PC 101. The wireless setting instruction includes the wireless profile information (including the SSID and the password) of the AP 102 serving as the connection target. That is, here, the CPU 201 provides the printer 103 with the identification information for the printer 103 to identify the external AP to which the PC 101 can connect. In the following description, the instruction to transition to the wireless setting mode again upon failure in the wireless setting is referred to as a mode re-entry instruction. Note that these instructions and information are transmitted to the printer 103 in one step, but they may be divided into a plurality of steps. Alternatively, for example, the identification information of the PC 101 may be transmitted at a timing of establishment of wireless direct connection between the PC 101 and the printer 103.

In step S312, the CPU 201 disconnects the wireless direct connection to the printer 103, and connects to the AP 102 again. Then, in step S313, if there is a wireless profile temporarily left from the wireless direct connection, the CPU 201 deletes it. This step is performed to avoid that a wireless profile unintended by the user is left.

In step S314, the CPU 201 searches for the printer 103 by infrastructure connection via the AP 102. More specifically, the CPU 201 receives identification information (MAC address or the like) from an apparatus connected to the AP 102. Then, the CPU 201 determines whether the received identification information includes identification information matching the identification information acquired from the printer 103 in step S306. Thus, it can be confirmed whether the printer 103 connects to the AP 102.

If it is determined in step S315 that the printer 103 can be detected by the search in step S314, the CPU 201 advances to step S316; otherwise, the CPU 201 advances to step S318.

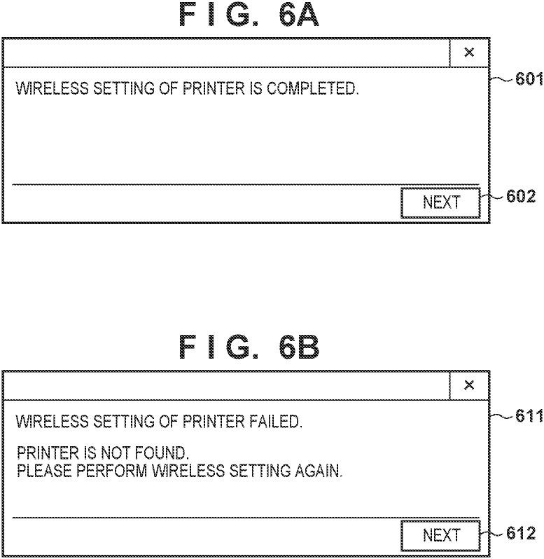

In step S316, the CPU 201 displays a setting success screen 601 as shown in FIG. 6A on the display apparatus 208. If the user selects a “next” button 602 on the setting success screen 601, the CPU 201 terminates the wireless setting instruction process (step S317). Note that the CPU 201 may connect the PC 101 to the printer 103 via the AP 102 at a timing of determining in step S315 that the printer 103 can be detected. Alternatively, the CPU 201 may connect the PC 101 to the printer 103 via the AP 102 at a timing of detecting pressing of the “next” button 602.

In step S318, the CPU 201 determines whether the connection process between the PC 101 and the printer 103 has failed in the automatic connection process. If it is determined in step S318 that the connection process between the PC 101 and the printer 103 has failed in the automatic connection process, the CPU 201 advances to step S319; otherwise, the CPU 201 advances to step S320. Examples of cases in which it is determined that the connection process between the PC 101 and the printer 103 has not failed in the automatic connection process include a case in which the connection process using a process of a Wi-Fi Protected Setup (WPS) Push Button Configuration (PBC) method has failed.

WPS is a standard for wireless setting defined in January 2007 by the Wi-Fi Alliance, a wireless LAN-related industry group. In the WPS PBC method, when a user presses the button of an apparatus and the button of an AP, the apparatus and AP automatically transition to the WPS mode. If the apparatus and the AP recognize each other in the WPS mode, they communicate information required for connection. This enables connection between the apparatus and the AP.

In step S320, the CPU 201 displays, as an error display, a setting failure screen 611 as shown in FIG. 6B on the display apparatus 208. That is, the CPU 201 performs display control of the display apparatus 208. Based on acceptance of a user selection by a “next” button 612 on the setting failure screen 611, the CPU 201 terminates the wireless setting instruction process (step S317). For example, if the connection process using the process of the WPS PBC method fails (No in step S318), it is determined that the connection process cannot be continued, and the setting failure screen 611 is displayed.

On the other hand, if the process advances to step S319 from step S304, S309, S310, or S318, the CPU 201 performs, in accordance with the cause of failure in the automatic connection process, the connection process that can be continued. In this embodiment, this process is referred to as a connection continuation process.

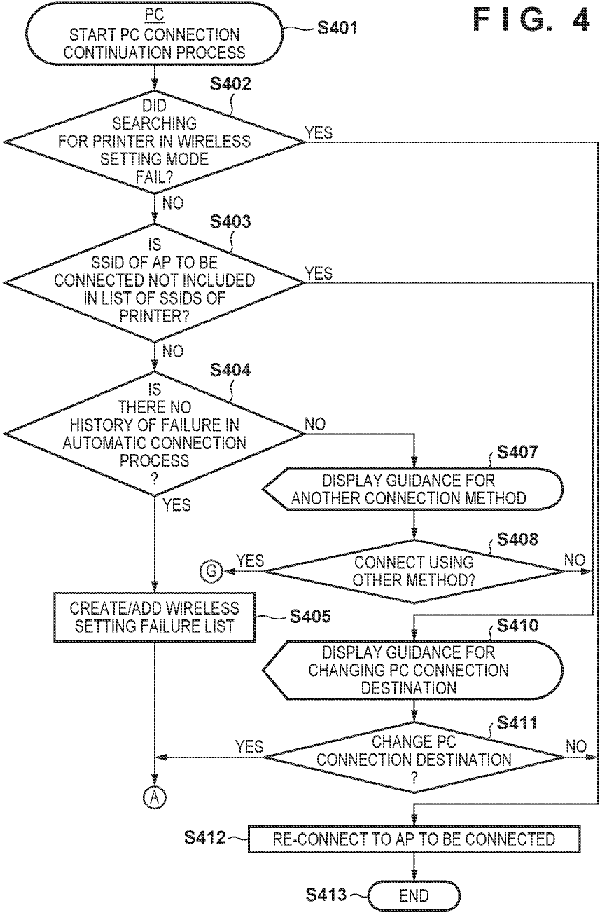

FIG. 4 is a flowchart illustrating a process example of the CPU 201, and illustrating a specific process example of the connection continuation process (step S319) shown in FIGS. 3A to 3C.

In step S402, if it is determined that the detection of the printer 103 set in the wireless setting mode has failed (No in step S304 → step S319), the CPU 201 determines that temporary connection between the PC 101 and the printer 103 cannot be established, and it is difficult to establish wireless infrastructure connection by the automatic connection process. Thus, the CPU 201 advances to step S412 to connect to the connection target AP 102 again, and terminates the connection continuation process (step S413). In this case, the CPU 201 advances step S320 in FIG. 3B, displays the setting failure screen 611 on the display apparatus 208, and terminates the flowchart of FIGS. 3A to 3C. On the other hand, if it is determined that the detection of the printer 103 set in the wireless setting mode has not failed, the CPU 201 advances to step S403.

In step S403, if it is determined that the SSID of the connection target AP 102 is not included in the list of SSIDs acquired from the printer 103 in step S306 (No in step S309 → step S319), the CPU 201 advances to step S410, switches the AP connected to the PC 101, and tires to perform the automatic connection process again. On the other hand, if it is determined that the SSID of the connection target AP 102 is included in the list of SSIDs acquired from the printer 103 in step S306, the CPU 201 advances to step S404.

FIG. 1C shows the system configuration in a case in which there is another AP 104 different from the connection target AP (AP 102 here) that can be confirmed from both the PC 101 and the printer 103. In this case, there is a possibility that wireless infrastructure connection between the PC 101 and the printer 103 can be established by switching the connection destination of the PC 101 to the AP 104 and performing the automatic connection process again.

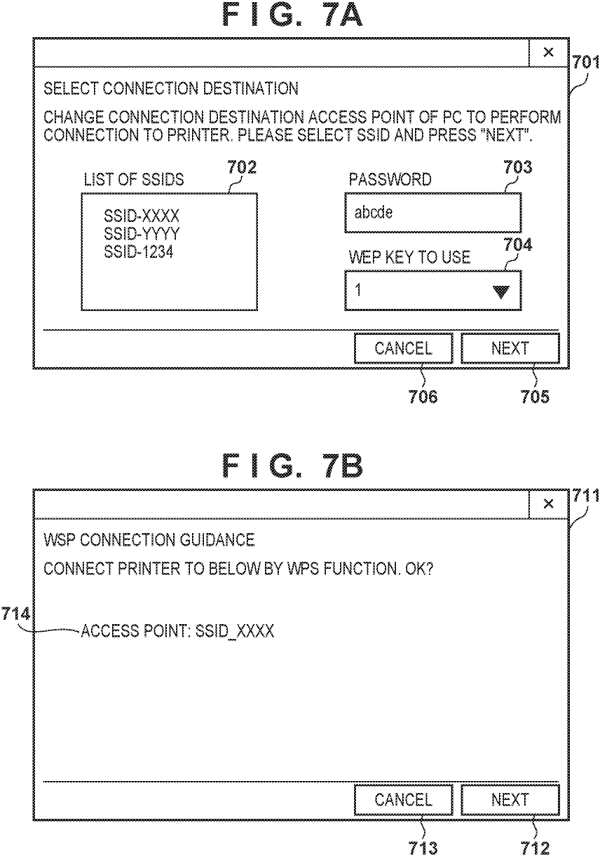

More specifically, in step S410, the CPU 201 displays a PC connection destination change screen 701 as shown in FIG. 7A, and accepts a selection as to whether to change the AP of the connection destination. The PC connection destination change screen 701 includes an SSID list 702, a password setting portion 703, a WEP key selection portion 704, a “next” button 705, and a “cancel” button 706. SSIDs searched for by the OS stored in the external storage apparatus 207 of the PC are listed in the SSID list 702. The user selects a desired SSID from the SSID list 702 and inputs, in the password setting portion 703, the password (characters or numbers) set for the selected SSID. If the communication performed via the SSID selected in the SSID list 702 is encrypted by WEP, the PC 101 activates the WEP key selection portion 704, and prompts the user to select the WEP key. Thereafter, if the user presses the “next” button 705, the CPU 201 closes the PC connection destination change screen 701 displayed by the display apparatus 208, and advances to step S411.

In step S411, if the connection destination AP of the PC 101 is to be changed (Yes in step S411), the CPU 201 changes the connection destination AP of the PC 101 to the AP specified by the SSID selected in step S410, and stores the SSID and password as a wireless profile in the ROM 202. Thereafter, the CPU 201 returns to the processing in step S302, and performs the automatic connection process again.

On the other hand, if the user presses the “cancel” button 706, and the PC 101 determines that the connection destination of the PC 101 is to be unchanged (No in step S411), the CPU 201 determines that the automatic connection process to the connection target AP cannot be performed, connects to the connection target AP again (step S412), and terminates the connection continuation process (step S413). In this case, the CPU 201 returns to the flowchart of FIGS. 3A to 3C, and performs display control of causing the display apparatus 208 to display the setting failure screen 611 in step S320.

Note that in this embodiment, a list of the SSIDs searched for by the OS is displayed in the SSID list 702 in FIG. 7A, but the preset invention is not limited to this. For example, only the SSIDs existing in both of the list of SSIDs searched for by the OS and the list of SSIDs acquired in step S306 may be displayed. Further, in this embodiment, the user is requested to operate the password setting portion 703 and the WEP selection portion 704, but it may be configured to use the wireless profile information of the SSID selected from the SSID list 702 if the information is stored in the ROM 202. Further, the user selects the SSID from the SSID list displayed in the PC connection destination change screen 701, but the present invention is not limited to this. For example, only guidance that the connection destination AP of the PC 101 is switched from the OS setting may be given to the user.

If it is determined in step S404 that there is no history of failure in the automatic connection process of the printer 103 to the connection target AP 102 (No in step S315 → Yes in step S318 → step S319), the CPU 201 advances to step S405, and creates or adds an automatic connection process failure list. FIG. 8 shows an example of the automatic connection process failure list. The unique SSID of the printer 103 and the SSID of the AP 102 for which the automatic connection process has been performed are associated with each other and stored in the external storage apparatus 207. The CPU 201 associates the SSID of the printer 103 of interest and the SSID of the AP 102 of interest with each other and stores them in the list. That is, the CPU 201 performs storage control of storing, in the external storage apparatus 207, failure information associating the identification information of the printer 103 and the identification information of the AP 102 with each other. Thereafter, the CPU 201 returns to the processing in step S302, and performs the automatic connection process again (step S406/S321).

On the other hand, if it is determined in step S404 that there is the history of failure in the automatic connection process (Yes in step S310 → step S319), the CPU 201 considers that the automatic connection process to the connection target AP is unlikely to be successful, and advances to step S407.

In step S407, the CPU 201 displays guidance for another connection method. For example, the CPU 201 displays a WPS guidance screen 711 on the display apparatus 208 as shown in FIG. 7B. Even if the automatic connection process has already failed once, wireless infrastructure connection between the PC 101 and the printer 103 may be established using another connection method different from the automatic connection process. Therefore, the CPU 201 prompts the user to connect using the other connection method.

In step S408, the CPU 201 accepts a user operation on the WPS guidance screen 711. If it is tried to connect the PC 101 to the printer 103 using the other method, the CPU 201 advances to step S409; otherwise, the CPU 201 advances to step S410.

Referring back to FIG. 7B, the WPS guidance screen 711 includes a “next” button 712, a “cancel” button 713, and a connection target AP information display portion 714. When the user performs a predetermined operation of the connection target AP in accordance with the guidance on the WPS guidance screen 711, the connection target AP is made to transition to the WPS mode. Then, it is necessary to make the printer 103 transition to the WPS mode, but there is a case in which the printer 103 cannot be made to transition to the WPS mode by a manual operation of the printer 103. Therefore, if the user presses the “next” button 712 (Yes in step S408), the CPU 201 transmits a WPS mode transition instruction to the printer 103. Then, the CPU 201 performs the process from step S312 of FIG. 3B. Thereafter, if the PC 101 determines in step S315 that the printer 103 connected to the connection target AP by the process of the WPS PBC method can be detected, the PC 101 performs the processing in step S316, and terminates the wireless setting instruction process (step S317).

On the other hand, if the user selects the “cancel” button 713 on the WPS guidance screen 711, the CPU 201 determines that the connection process using the process of the WPS PBC method is not performed (No in step S408), and advances to step S410.

Note that in this embodiment, if it is determined that a combination of the unique SSID of the connection target AP and the unique SSID of the printer, which established the P2P connection in step S305, is include in the automatic connection process failure list, connection by the WPS PBC method is guided as the next connection method. However, the connection method to be guided is not limited to this. For example, the PC 101 may communicate with the printer 103 using P2P connection, display the wireless connection setting screen for the printer 103 on the display apparatus 208 of the PC 101, and prompt the user for input. Further, even when using the PBC method, the present invention is not limited to WPS and, for example, a technique such as Airstation One-touch Secure System (AOSS) or “easy wireless start” may be used. The connection target AP information display portion 714 displays the SSID as the AP information, but the AP information to be displayed is not limited to this. For example, other information (MAC address or the like) indicating the connection target AP or the like may be included. In this embodiment, if Yes in step S310 and No in step S404, a guidance display in step S407 is first performed, and then the guidance display in step S410 is performed if No in step S408. However, the order is not limited to this. In this case, the guidance display in step S410 may be performed first and, if No in step S411, the guidance display in step S407 may be performed.

### Process Example of Printer 103

With reference to FIGS. 3A to 3C again, the wireless setting process of the printer 103 will be described in detail. This flowchart starts based on the CPU 252 determining that the printer 103 transitions to the wireless setting mode. For example, upon the user powering on the printer 103 on the input interface 259 of the printer 103, if the necessary initial settings are incomplete, the CPU 252 determines to automatically transition to the wireless setting mode. The printer 103 in the wireless setting mode operates the wireless LAN interface 256 as the AP specified by the SSID unique to the printer 103. The wireless LAN interface 256 operating as the AP is temporarily used upon performing connection setting. Due to a requirement to connect the PC 101 and the printer 103 without requiring input of the authentication information (password or the like) by the user or the like, the wireless LAN interface 256 operates as an AP with low security level. Therefore, transition to the wireless setting mode can be limited to specific conditions such as the timing of power-on without the necessary initial settings completed as descried above. Note that transition to the wireless setting mode may be performed based on another method. For example, transition to the wireless setting mode may be performed upon the user making a predetermined instruction on the display apparatus 258 or input interface 259 of the printer 103.

In step S352, after power-on and before transition to the wireless setting mode, the CPU 252 of the printer 103 searches for nearby AP and creates a list of SSIDs including the SSID of the detected AP.

In step S353, the CPU 252 transitions to the wireless setting mode.

In step S354, the CPU 252 checks whether an information acquisition request is received from the PC 101. In step S355, if the information acquisition request is received, the CPU 252 advances to step S356; otherwise, the CPU 252 advances to step S357.

In step S356, the CPU 252 transmits the information to the PC 101, and returns to step S354. Here, the CPU 252 transmits the information via the wireless LAN interface 256 by wireless direct connection. Examples of the information to be transmitted to the PC 101 are the list of SSIDs created in step S3 52 and the identification information (MAC address or the like) of the printer 103.

In step S357, the CPU 252 checks whether a wireless setting instruction , a mode re-entry instruction, and the identification information (MAC address or the like) of the PC 101 are received from the PC 101. In step S358, if it is determined that the wireless setting instruction is received, the CPU 252 advances to step S359. If it is determined that no wireless setting instruction is received, the CPU 252 returns to step S354. Note that the wireless setting instruction can include the wireless profile including the information such as the SSID of the connection target AP 102.

In step S359, the CPU 252 performs a connection process with the AP (AP 102) designated by the PC 101. More specifically, the CPU 252 performs a connection process with the AP 102 using the SSID and password included in the wireless profile received from the PC 101.

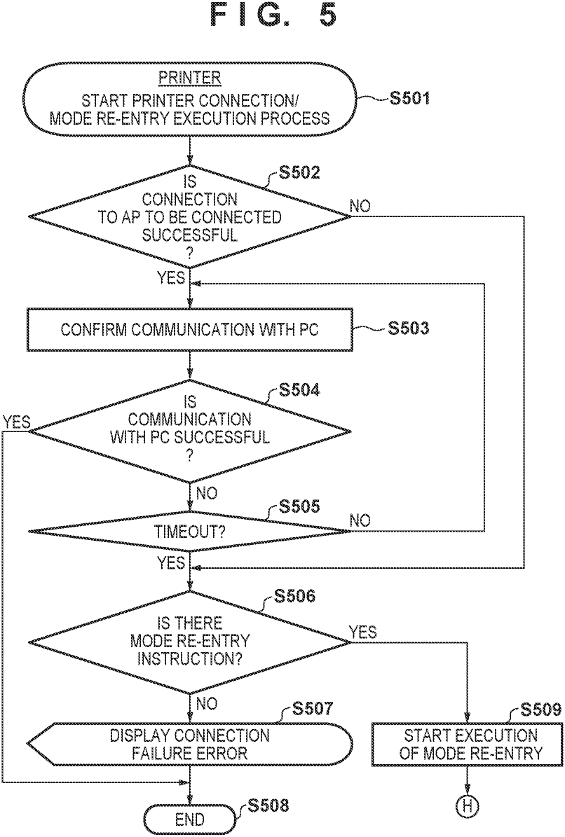

In step S360, the CPU 252 performs a connection/mode re-entry execution process. FIG. 5 is a flowchart illustrating a specific process example of the connection/mode re-entry execution process (step S360).

If it is determined in step S502 that connection to the control target AP is successful, the CPU 252 advances to step S503; otherwise, the CPU 252 advances to step S506.

In step S503, the CPU 252 performs a communication confirmation process with the PC 101. More specifically, when the PC 101 receives the identification information from the device connected to the connection target AP in step S314, the PC 101 communicates with the printer 103. At this time, if the identification information of the communication partner coincides with the identification information of the PC 101 received in step S357, the CPU 252 determines that connection to the PC 101 is established.

In step S504, as a result of the confirmation in step S503, if it is determined that connection to the PC 101 is established, the CPU 252 terminates the connection/mode re-entry execution process (step S508), and terminates the wireless setting process (step S361). If it is determined that connection to the PC 101 is not established, the CPU 252 advances to step S505.

In step S505, the CPU 252 performs timeout determination by determining whether the time elapsed since the first execution of processing in step S503 is longer than a predetermined threshold time set in advance. If it is determined that the timeout has occurred, the CPU 252 advances to step S506; otherwise, the CPU 252 returns to step S503. Here, the predetermined threshold time is set to a statistically calculated time that gives no stress to the user.

In step S506, if it is determined that no mode re-entry instruction is received in step S357, the CPU 252 advances to step S507; otherwise, the CPU 252 advances to step S509.

In step S507, the CPU 252 performs display control to display a connection failure error. The CPU 252 causes the display apparatus 258 of the printer 103 to display error contents. Then, the CPU 252 terminates the connection/mode re-entry execution process (step S508), and terminates the wireless setting process (step S361).

On the other hand, if it is determined that the mode re-entry instruction is received (Yes in step S506), the CPU 252 starts execution of the mode re-entry processing (step S509). More specifically, the CPU 252 returns to the processing in step S352 of FIG. 3C, creates a list of SSIDs, and starts the wireless setting mode again in step S353. With this operation, the CPU 252 can perform the processing in the wireless setting mode again.

As has been described above, according to this embodiment, before trying to establish wireless infrastructure connection (steps S312 to S316), the CPU 201 instructs the printer 103 to start the wireless setting mode again upon failure in the establishment (step S311). Accordingly, even if connection setting for establishing wireless infrastructure connection fails, connection setting between the PC 101 and the printer 103 can be readily performed again. Thus, the necessity for operation and manual setting of the printer 103 by the user upon failure in establishment of wireless infrastructure connection can be reduced, and the burden on the user to establish wireless infrastructure connection can be reduced. In a state in which the initial settings of the printer 103 are incomplete or the like, it is sometimes difficult to perform setting by directly operating the printer 103. However, even if establishment of wireless infrastructure connection fails, a process for establishing wireless infrastructure connection can be continued.

For example, as a comparison with this embodiment, consider a case in which the PC 101 does not transmit, to the printer 103, the instruction to start the wireless setting mode again upon failure in establishment of wireless infrastructure connection. In this case, upon failure in establishment of wireless infrastructure connection, at least one of the PC 101 and the printer 103 performs an error display to notify that establishment of wireless infrastructure connection has failed and display a countermeasure method. Then, the user is required to try another connection method with reference to the display, resulting in a burden on the user. On the other hand, according to this embodiment, even if establishment of wireless infrastructure connection fails once, the wireless connection process of the PC 101 and the printer 103 is continued as described above. Therefore, the burden on the user required until wireless infrastructure connection is finally established between the PC 101 and the printer 103 can be reduced.

Further, according to this embodiment, upon failure in establishment of wireless infrastructure connection, the CPU 201 continues the process for establishing wireless infrastructure connection in accordance with the cause of failure (steps S319/S401 to S413). Accordingly, a more appropriate process can be performed in accordance with the situation in retrying upon failure in establishment of wireless infrastructure connection, and it can be suppressed that establishment of connection fails again.

More specifically, an example of the cause of failure in establishment of wireless infrastructure connection is that the PC 101 cannot detect the printer 103 in the wireless setting mode (No in step S304 → Yes in step S402). In this case, temporary connection between the PC 101 and the printer 103 cannot be established, and it is considered that establishing wireless infrastructure connection by the automatic connection process is difficult. Therefore, the situation can be notified to the user by displaying on the display apparatus 208 of the PC 101 that wireless infrastructure connection has failed.

Another example of the cause of failure in establishment of wireless infrastructure connection is that the SSID of the connection target AP 102 is not included in the list of SSIDs acquired from the printer 103 by the PC 101 in step S306 (No in step S309 and Yes in step S403). In this case, wireless infrastructure connection may be established by setting, as the connection target AP, the AP whose SSID is included in the list of SSIDs. Therefore, by guiding to change the AP to be connected to the PC 101 (steps S410 and S411), it is possible to retry to establish wireless infrastructure connection by the automatic connection process while setting another AP as the target.

If there is a history of failure in connection setting between the AP 102 and the printer 103, trying to establish wireless infrastructure connection in the same method is likely to fail again. Therefore, if there is a history of failure, it is guided to perform another connection setting method with the AP 102 as the target or to perform connection setting with another AP different from the AP 102 as the target. With this, the possibility of establishing wireless infrastructure connection can be improved.

In this embodiment, the information processing apparatus is the PC, but the present invention is not limited to this, and various apparatuses such as a smartphone and a printer may be employed. Further, in this embodiment, the communication apparatus is the printer, but the present invention is not limited to this, and various apparatuses such as a PC and a smartphone may be employed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

For example, a flexible disk, hard disk, optical disk, magnetooptical disk, CD-ROM, CD-R, magnetic tape, nonvolatile memory card, ROM, or DVD may be used as a storage medium for supplying a program code.

It is needless to say that the present invention includes not only a case in which the function of the above-described embodiment is implemented by the computer executing the read program code, but also a case in which the OS (Operating System) or the like running on the computer executes a part or all of the actual processing based on the instruction from the program code and the function of the above-described embodiment is implemented by the processing.

Further, it is needless to say that the present invention also includes a case in which the program code read out from the storage medium is written in a memory provided in a function expansion board inserted into the computer or a function expansion unit connected to the computer and a CPU or the like provided in the function expansion board or the function expansion unit executes a part or all of the actual processing based on the instruction from the program code, so that the function of the embodiment described above is implemented by the processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-202769, filed Dec. 14, 2021, which is hereby incorporated by reference herein in its entirety.

What is claimed is:

1. A control method of an information processing apparatus that communicates with a communication apparatus, comprising:
establishing, between the information processing apparatus and a communication apparatus that has started a wireless connection setting mode, temporary first connection without intervention of an external access point of the communication apparatus and the information processing apparatus;
providing, using the first connection, the communication apparatus with identification information for identifying the external access point;
trying to establish, between the communication apparatus and the information processing apparatus, second connection via the external access point identified by the identification information provided to the communication apparatus; and
transmitting, before trying to establish the second connection, to the communication apparatus, an instruction for controlling the communication apparatus such that the communication apparatus starts the setting mode upon failure in establishment of the second connection.

2. The method according to claim 1, further comprising
continuing, upon failure in establishment of the second connection, a process of establishing the second connection in accordance with a cause of failure in the second connection.

3. The method according to claim 1, further comprising:
searching for an apparatus with which the first connection can be established; and
displaying, on a display unit of the information processing apparatus, information indicating that establishment of the second connection to the communication apparatus has failed if the communication apparatus cannot be detected by the searching.

4. The method according to claim 3, wherein
in the establishing the first connection, the first connection to the communication apparatus is established if the communication apparatus is detected by the searching, and
the method further comprises:
acquiring, from the communication apparatus using the first connection, a list including identification information of an access point to which the communication apparatus can connect; and
changing, if identification information of a first access point serving as the external access point is not included in the list acquired by the acquiring, the external access point to be connected to the information processing apparatus to a second access point different from the first access point.

5. The method according to claim 4, further comprising
accepting a selection as to whether to change, by the changing, the external access point to be connected to the information processing apparatus.

6. The method according to claim 5, further comprising
displaying, on the display unit of the information processing apparatus, information indicating that establishment of the second connection has failed if it is accepted, by the accepting, that the external access point to be connected to the information processing apparatus is not changed.

7. The method according to claim 1, further comprising
causing, if a second establishment unit has failed establishment of the second connection, storing failure information associating the identification information of the external access point and identification information of the communication apparatus in a storage unit of the information processing apparatus.

8. The method according to claim 7, wherein
in the trying to establish the second connection, upon failure in establishment of the second connection, if the failure information is already stored in the storage unit, establishment of the second connection is tried using a method different from a method used in the case of failure.

9. The method according to claim 8, further comprising
accepting a selection as to whether to try to establish the second connection using the different method in the trying to establish the second connection.

10. The method according to claim 9, wherein
in the trying to establish the second connection, if it is accepted that establishing the second connection using the different method is not tried, the external access point to be connected to the information processing apparatus is changed, and then the second connection is established using the same method as in the case of failure in establishment of the second connection.

11. The method according to claim 9, further comprising
displaying, if it is accepted that establishing the second connection using the different method is tried, and establishment of the second connection using the different method fails in the trying to establish the second connection, information indicating that establishment of the second connection has failed on a display unit of the information processing apparatus.

12. A communication apparatus that communicates with an information processing apparatus,
the information processing apparatus comprising:
a first establishment unit configured to establish, between the information processing apparatus and a communication apparatus that has started a wireless connection setting mode, temporary first connection without intervention of an external access point of the communication apparatus and the information processing apparatus;
a provision unit configured to provide, using the first connection, the communication apparatus with identification information for identifying the external access point;
a second establishment unit configured to try to establish, between the communication apparatus and the information processing apparatus, second connection via the external access point identified by the identification information provided to the communication apparatus; and
an instruction unit configured to transmit, before trying to establish the second connection, an instruction for controlling the communication apparatus such that the communication apparatus starts the setting mode upon failure in establishment of the second connection, and
the communication apparatus comprising:
a confirmation unit configured to confirm, upon failure in establishment of the second connection to the information processing apparatus, whether the instruction is received from the information processing apparatus; and
a transition unit configured to transition to the setting mode if it is confirmed by the confirmation unit that the instruction is received.

13. The communication apparatus according to claim 12, further comprising
a fourth display control unit configured to display, on a display unit of the communication apparatus, information indicating that establishment of the second connection to the information processing apparatus has failed, if establishment of the second connection to the information processing apparatus has failed and it is not confirmed by the confirmation unit that the instruction is received.

14. An information processing apparatus that communicates with a communication apparatus, comprising:
a first establishment unit configured to establish, between the information processing apparatus and a communication apparatus that has started a wireless connection setting mode, temporary first connection without intervention of an external access point of the communication apparatus and the information processing apparatus;
a provision unit configured to provide, using the first connection, the communication apparatus with identification information for identifying the external access point;
a second establishment unit configured to try to establish, between the communication apparatus and the information processing apparatus, second connection via the external access point identified by the identification information provided to the communication apparatus; and
an instruction unit configured to transmit, before trying to establish the second connection, an instruction for controlling the communication apparatus such that the communication apparatus starts the setting mode upon failure in establishment of the second connection.
